(19) United States
(12) Patent Application Publication
(10) Pub. No.: US 2006/0062218 A1
(43) Pub. Date: Mar. 23, 2006

(54) Method for establishing session in label switch network and label switch node

(76) Inventor: Yasushi Sasagawa, Kawasaki (JP)

Correspondence Address: KATTEN MUCHIN ROSENMAN LLP, 575 MADISON AVENUE, NEW YORK, NY, 10022-2585, US

(21) Appl. No.: 11/262,188

(22) Filed: Oct. 28, 2005

Related U.S. Application Data
(63) Continuation of application No. PCT/JP03/08710, filed on Jul. 9, 2003.

(51) Int. Cl. H04L 12/56

(52) U.S. Cl. 370/389

(57) ABSTRACT

In a label switch network such as an MPLS, message exchange between adjacent label switch nodes by a label distribution protocol is performed by adding session identification information to the message for identifying a session to be established between the nodes, and the nodes respectively establish a plurality of sessions to be used in the same label space between the same adjacent label switch nodes based on the session identification information. As such, the simplification in designing, the improvement in flexibility, the improvement in efficiency of maintenance/operation/management, etc., of the label switch network can be expected.

### CROSS REFERENCE TO RELATED APPLICATIONS

This application is based on and hereby claims priority to International Application No PCT/JP2003/008710 filed on 9 Jul. 2003 in Japan, the contents of which are hereby incorporated by reference.

### BACKGROUND OF THE INVENTION

(1) Field of the Invention

The present invention relates to a method for establishing a session in a label switch network and a label switch node and, more particularly, to a technique suitable for a use in a network or a node adopting an MPLS (Multi Protocol Label Switching) or a protocol, which is an extended MPLS.

(2) Description of Related Art

Conventionally, proposed technologies to realize communication satisfying the real-time property of the video of high definition in a limited area and high speed transfer of large capacity data, include, for instance, a technique described in Japanese Patent Laid-Open (Kokai) 2000-232454 (hereinafter, referred to as Patent document 1) (AREA LIMITED-TYPE HIGH SPEED COMMUNICATION SYSTEM AND SERVICE REALIZING METHOD). The technique in Patent document 1 is an area limited-type high speed communication system using a well-known high speed LAN technique such as a gigabit LAN (Local Area Network), in which by performing data transfer using a communication frame containing an area ID for identifying a limited area, an industry ID for identifying the type of business of a user, and a user ID for identifying a user, high speed data communication of high definition video is to be executed between the users in limited areas who use the video of high definition.

As such, the MPLS is in the process of being employed recently in order to make it possible to explicitly specify a packet transfer path, which has been difficult of being realized with a conventional router, to improve usage efficiency of a link by preventing a deviation of paths, and to realize an IP-VPN (Internet Protocol-Virtual Private Network) on the Internet, and its research, development, and improvement (extension) and the like are being promoted.

Here, the MPLS is a technology for routing IP packets by using short, fixed-length path identification information called a “label” instead of an IP header, wherein a necessary “label” is exchanged between routers that support the MPLS [generally, referred to as an LSR (Label Switching Router)] by a predetermined label distribution protocol (LDP).

Recently, on the other hand, apparatuses (packet repeater, TDM repeater, optical wavelength repeater, etc.) implementing a G (Generalized) MPLS [also referred as an MP (λ) S], as an extended version of the MPLS, which uses a time slot of TDM (Time Division Multiplexing) or an optical wavelength (λ) of a photonic network as a “label”, and networks and applications configured by using these [MPLS L2 (Layer 2) VPN, MPLS L3 (Layer 3) VPN, MPLS-TE (Traffic Engineering), GMPLS, etc.] are also being developed. The outline of the MPLS technique will be explained below.

[1] Identification of Label Distribution Protocol (LDP)

As described in subsection 2.2.2 of the RFC (Request For Comments) 3036 (LDP Specification) (Non-patent document 1), an LDP identifier is composed of six octets in total, that is, an LSR (Label Switching Router) identifier (LSR ID) (four octets) and a Label space ID (two octets), and identifies an LDP session between adjacent LSRs and at the same time, identifies the Label space transmitted by the LSRs. Here, the “LSR ID” is a global value for identifying an LSR and it is normally recommended to use a router ID. Further, the “Label space ID” is a value for identifying the Label space used in the LSR.

Then, as the “Label space”, “per interface” and “platform-wide” are specified and when the latter “platform-wide” is used, it is specified that the Label space ID=0.

Hence, it is impossible to set a plurality of LDP sessions using the same Label space between same adjacent LSRs (it could be made possible in the event of changing the LSR ID, however, in this case, the LSR would need to be divided logically).

[2] Basic Discovery Mechanism and Extended Discovery Mechanism

Next, the usage and outline of the basic discovery mechanism and the extended discovery mechanism will be explained below.

First, the former “basic discovery mechanism” is used to automatically detect an adjacent LSR directly (physically) connected and to establish Hello adjacency, while the latter “extended discovery mechanism” is used to detect an adjacent LSR not connected directly and to establish Hello adjacency.

Then, in the “basic discovery mechanism”, by transmitting a Hello Message using the destination IP address being a multicast address (224.0.0.2) by a UDP (User Datagram Protocol) packet, Hello adjacency is automatically detected (detected upon receipt of a Hello Message from the adjacent LSR). Therefore, in the “basic discovery mechanism”, there is no need for any provisioning (pre-setting) for establishing Hello adjacency. As a transmission source IP address of a Hello Message, the IP address of its own interface is used, however, as to which address is to be employed concretely it depends on design items in terms of implementation or implementation forms (for example, the interface address, loop back address, LDP session dedicated address, etc., can be used).

On the other hand, in the “extended discovery mechanism”, by transmitting a Hello Message using the destination IP address as a specific unicast IP address by a UDP packet, an adjacent LSR not connected directly is detected and Hello adjacency is established. As a consequence, in the “extended discovery mechanism”, provisioning for establishing Hello adjacency is needed. In this case also, as a transmission source IP address, the IP address of its own device (as to which address is to be employed concretely, it depends on the design items in terms of implementation) is used.

[3] LDP Session Establishment Sequence

Next, the procedure of establishing an LDP session is explained with reference to FIG. 16. As shown in FIG. 16, in the LDP, exchange of a Hello Message is first performed between adjacent LSR#1 and LSR#2 (step A1) and after Hello adjacency is established (step A2), by performing exchange of a TCP (Transmission Control Protocol) message (steps A3, A4, A5), a transport connection (TCP) is established (step A6) and further, after exchange of an Initialization Message is performed and predetermined session parameters are permitted by each other, by periodically performing exchange of a Keep Alive Message (steps A7 to A12), an LDP session is established (step A13).

After the LDP session is established, exchange of the address of an LDP peer used for forwarding decision of an MPLS packet (a labeled packet) is performed between LSR#1 and LSR#2 by an Address Message, and label distribution (label mapping) is performed by performing exchange of a Label Mapping Message based on the Address Message (steps A14 to A16), thereby forwarding of an MPLS packet attached with the distributed label is made possible at each of LSR#1 and LSR#2.

For the present, unmatch of a label advertisement mode, which will be described later, is not to be grasped (cannot be detected) before the above-mentioned exchange of the Initialization Message.

[4] “Martini” Scheme MPLS L2 VPN

Next, in the “Martini” scheme [a scheme that uses an MPLS and provides a pseudo wire (PW) in L2 (Layer 2)], which is one of the MPLS L2 VPNs (Virtual Private Networks), as a new “Forwarding Equivalence Class (FEC)” type, a “PW FEC element” and its corresponding PW [its former name is VC (Virtual Channel)] TLV (Type/Length/Value) are defined additionally, however, for others, the LDP is used basically. More specifically, the “downstream unsolicited” mode and the extended discovery mechanism are used. The most recent version of the “Martini” scheme is described in the WG draft of pwe3 WG (Pseudo Wire Emulation Edge to Edge Working Group) of the IETF (Internet Engineering Task Force) as Non-patent documents 2, 3, etc., and it is expected to be standardized.

Hereinafter, in view of the establishment of an LDP session and the establishment of an LSP (Label Switched Path), the outline of the “Martini” scheme is explained with reference to a network configuration example shown in FIG. 17. In FIG. 17, PE#1, PE#2, and PE#3 each denote an LSR called a Provider Edge to be connected to another network, the Core LSR is one other than these, and PE#1 is physically connected to the Core LSR, PE#2 to the Core LSR and PE#3, and PE#3 to the Core LSR and PE#2, respectively (indicated by the solid lines).

[Establishment of LDP Session]

(1) Establishment of Control Message Communication Path

For establishment of an LDP session and establishment of an LSP, which will be shown in section (2) and the following sections described below, there is a need to enable the transmitting and receiving of a control message such as an OSPF (Open Shortest Path First) and an LDP in all of the LSRs [PEs, core LSRs].

Here, in the “Martini” draft, encapsulating of the control message is not prescribed particularly. Therefore, there are conceivable some cases for the control message: (a) TCP/IP as it is (no encapsulation; OSPF-IP, LDP-TCP], (b) it is encapsulated with a label (it passes through an LSP set in advance), and (c) others [L2TP (Layer 2 tunneling protocol), GRE (Generic Routing Encapsulation), etc.].

In the case of (b) described above, there is a need to establish an LSP using some method [static, LDP, CR (Constraint Routed)-LDP, RSVP-TE (Resource ReserVation Protocol for traffic engineering), etc.].

(2) Establishment of Normal LDP Session

As shown by solid line arrows 100, 200, 300, and 400 in FIG. 18, the normal LDP sessions are established between all of adjacent LSRs (PEs, core LSRs) using the above-mentioned “basic discovery mechanism”.

(3) Establishment of LDP Session Between PEs

As shown by dotted line arrows 500, 600, and 700 in FIG. 18, the LDP sessions are established in a full mesh pattern between all of PEs (between PE#1 and PE#2, between PE#1 and PE#3, and between PE#2 and PE#3) using the “extended discovery mechanism”. At this time, provisioning needs to have been set up or carried out in terms of all of the IP addresses of the connection destination (remote side) LSRs for each of PE#1, PE#2, and PE#3.

However, as shown in FIG. 18, PE#2 and PE#3 are connected directly and the LDP session 400 is already established according to the above-mentioned “(1) Establishment of control message communication path”, therefore, there is no need to set up the LDP session 700 newly. According to the specification of RFC3036, strict setting is not enabled. However, unless PE#2 and PE#3 should have the knowledge that they are adjacent to each other, they would attempt to set this session. In this regard, the following implementations (a) to (c) are conceivable.

(a) By provisioning, their adjacency is indicated explicitly and setting of the session 700 is omitted.

(b) That the normal LDP session 400 between PE#2 and PE#3 is already set is checked and the setting of the session 700 is omitted.

(c) They attempt to set the session 700 without executing any checking; however, setting is resultantly impossible due to the same session as the normal LDP session 400.

However, in FIG. 19, if the link between PE#2 and PE#3 cannot be used for some reason, for example, it is necessary to set an LDP session between PE#2 and PE#3 using the “extended discovery mechanism”. Therefore, options are to be (b) or (c) described above.

As described above, in the “Martini” scheme, encapsulation of a control message is not specified, so that, in the event that the normal LSPs 500A, 500B, 600A, 600B, 700A, and 700B are already set as shown in FIG. 20, there is the possibility that the sessions 500, 600, and 700 are set (an LDP session is established through the LSP) in the LSPs 500A, 500B, 600A, 600B, 700A, and 700B (depending on the implementation/operation policy of the network and device).

By the way, the LSP has the unidirectional attribute, therefore, in FIG. 20, the set of the LSPs 500A and 500B indicates the normal LDP session 500 between PE#1 and PE#2, the set of the LSPs 600A and 600B indicates the normal LDP session 600 between PE#1 and PE#3, and the set of the LSPs 700A and 700B indicates the normal LDP session 700 between PE#2 and PE#3.

[Setting Example of LSP]

(1) Establishment of Normal LSP

Based on the IP paths, the normal LSPs are established as shown by thick solid line arrows 500A, 500B, 600A, 600B, 700A, and 700B in FIG. 21. Here, the LSPs 500B and 600B from PE#2 and PE#3 extending toward PE#1 are merged in the core LSR.

(2) Establishment of PW LSP

A PW LSP is established by distributing a label in a “Label Mapping” message with the above-mentioned PW FEC added thereto on the LDP sessions 500, 600, and 700 set between the above-mentioned PEs. Here, the PW is composed of a pair of PW LSPs having opposite directions between the same PEs (PW LSPs 500a and 500b, PW LSPs 600a and 600b, or PW LSPs 700a and 700b shown in FIG. 21), and associated with each other by the PW ID in the PW FEC. Provisioning is required to be carried out in terms of the PW ID in advance in both of the PEs. In FIG. 21, the PW LSPs 700a and 700b between PE#2 and PE#3 may be made to run through the tunnel LSPs 700A and 700B as shown schematically, or may be set independently of the tunnel LSPs 700A and 700B. However, even when they are made to run through the tunnel LSPs 700A and 700B, no tunnel label is appended if PHP is used.

In the “Martini” scheme, there is no specification about the tunneling of the PW LSP. Therefore, there are conceivable various variations about the tunnel LSP because of the reasons relating to the management/operation (for example, the control message and user data are separated to facilitate management) or relating to service [for example, provision of QoS (Quality of Service)/CoS (Class of Service) about user data]. Variations are shown below. Although not described in detail here, the tunnel may be set using one other than LSP.

(a) Establishment in Normal LSP

A PW LSP is established by using an LDP session between PEs. Here, as the direct paths between PE#1 and PE#2 and between PE#1 and PE#3, there exist only the normal LSPs 500A, 500B, 600A, and 600B shown in FIG. 21 (500B and 600B are merged by the core LSR), therefore, these LSPs 500A, 500B, 600A, and 600B are used as the tunnel LSP inevitably.

On the other hand, there exist the IP path and the normal LSPs 700A and 700B as a direct path between PE#2 and PE#3, therefore, there is a need to determine which one is to be used on the basis of the selection policy of the network or the device. The characteristics thereof are shown below.

An LSP can be set easily (no need to set a special tunnel LSP).
There is the possibility that a control message and user data can coexist in the same tunnel.
The tunnel LSP enables realizing of only the best effort service.

(b) Establishment in PW Dedicated LSP (Part 1; Setting in the Tunnel LSP Statically Set).

An LSP equivalent to the above-mentioned normal LSP is set statically. In this case, there are the following characteristics.
Provisioning is needed for all of the PEs and LSRs for setting a tunnel LSP.
A control message and user data can be separated.
A path can be set independently of the IP path.
Application of QoS/Cos is enabled.

(c) Establishment in PW Dedicated LSP (Part 2; Setting in the Tunnel LSP Set by the CR-LDP/RSVP-TE).

An LSP equivalent to the above-mentioned normal LSP is set by the CR-LDP/RSVP-TE. In this case, there are the following characteristics.
Provisioning is needed for all of the PEs for setting a tunnel LSP.
A control message and user data can be separated.
A path can be set independently of the IP path.
Application of QoS/Cos is enabled.

(d) Establishment in PW Dedicated LSP (Part 3; Setting in the Tunnel LSP Set by the LDP)

When there exist a plurality of normally set LSPs between the PEs, an LSP among them, which is not used, is used as a PW dedicated LSP. In this case, there are the following characteristics.
Provisioning is not needed.
Generally, it cannot be used (because when there exists only one IP path (or a physical path) between PE#1 and PE#2 and between PE#1 and PE#3 as described above, it is not possible to set a plurality of LSPs for the same FEC: conversely speaking, if the FEC is divided, it is enabled)
A control message and user data can be separated.
A path cannot be selected independently of the IP path.
Only the best effort service can be realized.

As described above, the already existing MPLS and its extended scheme have the following characteristics.

(1) Various variations exist for the path/encapsulation of the control message (some provisioning is necessary as the case may be).

(2) Various variations exist also for the tunnel (LSP) through which a PW passes (some provisioning is necessary as the case may be).

(3) Provisioning is necessary for the address for an LDP session on the remote side (because of not being connected directly to the remote side).

(4) If provisioning should be carried out by mistake for the LDP entity that does not implement “Martini” as an address on the remote side, it would not be grasped whether the LDP entity on the remote side can process the “PW FEC element” before exchange of a Label Mapping Message (or, it would not be grasped whether provisioning has been carried out so as to enable processing).

(5) The PW ID is subjected to provisioning at both PEs related thereto and is notified by the Label Mapping Message. Therefore, the error of provisioning is also not grasped before exchange of the Label Mapping Message (the error cannot be detected).

By the way, it is not possible to set a plurality of session between the same adjacent LSRs by the LDP (Label distribution protocol), which is most wide spread as a Signaling protocol wide spread mainly in carrier networks (when the same Label space is used), nor to explicitly identify or discriminate an application or its usage utilizing the LDP session set between the same adjacent LSRs.

Therefore, it is not to be grasped whether the LDP entities on both sides of the session implement an extended version of the “Martini” scheme or, if so, whether provisioning is carried out so as to use it before the phase of label mapping. Further, even in the case where both implement the “Martini” scheme and are set so as to use it, if various pieces of provisioning information in the MPLS L2 VPN of the “Martini” scheme are erroneous, it cannot be detected on the protocol, resulting in an erroneous operation, or, even if it can be detected, it is not possible to detect it without fail at the time of establishment of the LDP session.

A specific example is explained below with reference to a network configuration shown in FIG. 17.

(1) Prerequisites

(a) The PE#1 is a device which cannot transmit or receive an IP packet (control message) as it is, and which can transmit and receive only an IP packet encapsulated by the MPLS (when the “Martini” scheme is implemented on a bridge base device, such implementation is conceivable in view of the restriction of hardware and the cost of implementation). Further, it is assumed that this device has the ability to dynamically set an LSP other than the above-mentioned LSP by the LDP.

(b) PE#2, PE#3, and the core LSR can transmit and receive an IP packet as it is and can also transmit and receive an IP packet encapsulated by the MPLS.

(c) As an operation policy of a network, a control message is transmitted and received in an LSP and further a PW tunnel LSP and the LSP for the afore-mentioned control message are separated.

(2) From the above-mentioned prerequisites (a) and (b), it is necessary for an LSP for a control message to be statically set between PE#1 and the core LSR. Further, it is required to set an operation policy that a control message is transmitted and received in an LSP for PE#2, PE#3, and the core LSR. At this time, explicit provisioning, setting of priority of an IP path and an LSP path, etc., are conceivable.

(3) From the above-mentioned prerequisite (c), it is necessary to set PW tunnel LSPs in a full mesh pattern between PE#1, PE#2, and PE#3 separately from an LSP for a control message.

(4) It is prohibited for PE#1, PE#2, and PE#3 to transmit a control message in the LSP set in section (3) described above.

The above-mentioned network conditions have the following problems.

(a) As for PE#2, PE#3, and the core LSR, if the setting of an operation policy that a control message is transmitted and received in an LSP is erroneous, an LDP session between PE#2 and PE#3 is established, however, none of the LDP sessions between PE#1 and PE#2, between PE#1 and PE#3, and between PE#2 and PE#3 is established or either of them is not established.

(b) As for PE#1, PE#2, and PE#3, if the setting of an operation policy that a PW tunnel LSP and an LSP for a control message are separated is erroneous, a PW tunnel LSP may not be set, or even if a PW tunnel LSP can be set, both ends thereof may have deviated recognitions: one end may set a PW LSP using an LSP for a control message and the other may set a PW LSP using a PW tunnel LSP, and as a result, a frame in a PW may not be processed correctly.

(c) If provisioning of an address on the remote side is erroneous on setting LDP sessions between PE#1 and PE#2, between PE#1 and PE#3, and between PE#2 and PE#3, the LDP session is not set. Depending on implementation, an LDP session itself can be set, however, a PW LSP cannot be set using the session.

(d) If provisioning of each PW ID between PE#1 and PE#2, between PE#1 and PE#3, and between PE#2 and PE#3 is erroneous, a PW cannot be set correctly. Then, it cannot be grasped by an LDP before the phase of label mapping.

On the other hand, an application of the MPLS extends an LDP or uses as it is, and is standardized one after another or is being developed uniquely. Here, some applications cannot use the same LDP session. For example, the label advertisement mode of the LDP is not compatible between the “Downstream Unsolicited” mode and “Downstream on Demand”, therefore, when applications use different modes, the same LDP session cannot be used and as for the protocol, even if the same LDP session can be used, from the aspects of management, operation, and maintenance, there may be occasionally a case where it is desired that an LDP session be separated from another for each application and/or a usage.

For example, even if an attempt is made to implement traffic engineering and the “Martini” scheme, respectively, the traffic engineering uses the normal “Downstream on Demand” and the “Martini” scheme uses the “Downstream Unsolicited” mode, therefore, implementation is not enabled. Further, for example, when implementing the “Martini” scheme, even if an attempt is made to set an LSP tunnel for a control message and a PW LSP tunnel independently of each other using the LDP from the aspects of management, operation, and maintenance, it is not enabled.

Patent Document 1

Japanese Patent Laid-Open (Kokai) 2000-232454

Non-Patent Document 1

L. Andersson et al., “LDP specification” (Request for Comments), [online] January 2003, Network Working Group Internet Draft of IETF [searched, Jun. 16, 2003], Internet <http://www.ietf.org/xfc/xfc3036.txt>

Non-Patent Document 2

Luca Martini et al., “Transport of Layer 2 Frames Over MPLS” (draft-ietf-pwe3-control-protocol-01.txt), November 2002, Network Working Group Internet Draft of Internet Engineering Task Force (IETF).

Non-Patent Document 3

Luca Martini et al., “Encapsulation Methods for Transport of Ethernet Frames Over IP/MPLS Networks” (draft-ietf-pwe3-ethernet-encap-01.txt), [online], February 2002, Network Working Group Internet Draft of IETF [searched, Jun. 16, 2003], Internet <URL: http://www.ietf.org/internet-drafts/draft-ietf-pwe3-ethernet-encap-01.txt>.

The present invention has been devised in view of the above problems, and an object thereof is to make it possible to set a plurality of LDP sessions using the same Label space between the same adjacent LSRs, to make it possible to explicitly indicate an application and/or its usage utilizing the session, and to make it possible to detect erroneous provisioning and/or an erroneous connection of a session due to this at an early stage on establishing a session by connecting the LDP session correctly.

Another object is to prevent an erroneous operation of the MPLS and an application due to erroneous provisioning and further, to reduce erroneous connections or erroneous operations due to erroneous provisioning by automatically detecting provisioning information about the remote side LSR and obviating (or reducing) provisioning on the remote side.

### SUMMARY OF THE INVENTION

In order to attain the above-mentioned objects, a method for establishing a session in a label switch network of the present invention is characterized in that the label switch network comprises a plurality of label switch nodes having a function of routing a received packet according to label information distributed by a predetermined label distribution protocol, wherein: message exchange between adjacent label switch nodes by the label distribution protocol is performed by adding session identification information to the message for identifying a session to be established between the same adjacent label switch nodes; and the same adjacent label switch nodes respectively establish a plurality of sessions to be used in the same label space between the same adjacent label switch nodes based on the session identification information.

Further, a method for establishing a session in a label switch network of the present invention is characterized in that the label switch network comprise a plurality of label switch nodes having a function of routing a received packet according to label information distributed by a predetermined label distribution protocol, wherein: message exchange between adjacent label switch nodes by the label distribution protocol is performed by adding session type information to the message for explicitly indicating one of or both of an application and its usage utilizing a session to be established between the adjacent label switch nodes; and the adjacent label switch nodes respectively establish the sessions in accordance with the session type information between the adjacent label switch nodes based on the session type information.

Furthermore, a method for establishing a session in a label switch network of the present invention is characterized in that the label switch network comprises a plurality of label switch nodes having a function of routing a received packet according to label information distributed by a predetermined label distribution protocol, wherein: message exchange between adjacent label switch nodes by the label distribution protocol is performed by adding session identification information to the message for identifying a session to be established between the adjacent same label switch nodes as well as session type information explicitly indicating one of or both of an application and its usage utilizing the session; and the same adjacent label switch nodes respectively establish a plurality of sessions to be used in the same label space between the same adjacent label switch nodes based on the session identification information as well as the session type information.

Here, exchange of session type information may be performed by adding the session type information to a hello message as the message between the adjacent label switch nodes on establishing hello adjacency between the adjacent label switch nodes or exchange of session type information may be performed by adding the session type information to an initialization message as the message between the adjacent label switch nodes on establishing session between the adjacent label switch nodes.

Further, on establishing the session between adjacent label switch nodes, exchange of provisioning information about the entity of the label distribution protocol may be performed by adding the provisioning information to the message.

A label switch node of the present invention is characterized by having a function of routing a received packet according to label information distributed by a predetermined label distribution protocol and by comprising: a label distribution protocol processing section adapted to perform exchange of the message by adding session identification information for identifying a session to be established between the same adjacent label switch nodes to a message to be transmitted to and received from an adjacent label switch node by the label distribution protocol; and a session establishment control section for controlling the establishment of a plurality of sessions to be used in the same label space with the adjacent label switch node based on session identification information added to a message by the label distribution protocol received from the adjacent label switch node by the label distribution protocol processing section.

Further, a label switch node of the present invention is characterized by having a function of routing a received packet according to label information distributed by a predetermined label distribution protocol and by comprising: a label distribution protocol processing section adapted to perform exchange of the message by adding session type information explicitly indicating one of or both of an application and its usage utilizing a session to be established with the adjacent label switch node to a message to be transmitted to and received from an adjacent label switch node by the label distribution protocol; and a session establishment control section for controlling the establishment of the session in accordance with the session type information with the adjacent label switch node based on session type information added to a message by the label distribution protocol received from the adjacent label switch node by the label distribution protocol processing section.

Furthermore, a label switch node of the present invention is characterized by having a function of routing a received packet according to label information distributed by a predetermined label distribution protocol and by comprising: a label distribution protocol processing section adapted to perform exchange of the message by adding session identification information for identifying a session to be established with the adjacent label switch node as well as session type information explicitly indicating one of or both of an application and its usage utilizing the session to a message to be transmitted to and received from an adjacent label switch node by the label distribution protocol; and a session establishment control section for controlling the establishment of a plurality of sessions in accordance with the session type information to be used in the same label space with the adjacent label switch node based on session identification information and session type information added to a message by the label distribution protocol received from the adjacent label switch node by the label distribution protocol processing section.

Here, the label distribution protocol processing section may be configured such that it comprises a hello message processing section adapted to exchange the session type information with the adjacent label switch node on establishing hello adjacency with the adjacent label switch node by adding the session type information to a hello message as the message by the label distribution protocol.

The label distribution protocol processing section may be configured such that it comprises an initialization message processing section for exchanging the session type information with the adjacent label switch node on establishing a session with the adjacent label switch node by adding the session type information to an initialization message as the message by the label distribution protocol.

The label distribution protocol processing section may be configured such that it comprises a provisioning information exchange processing section for exchanging provisioning information about the entity of the label distribution protocol by adding it to the message.

The label distribution protocol processing section may be configured such that it comprises a tunnel label switch path setting section for setting a tunnel label switch path in advance with the adjacent label switch node when the session is established by the session establishment control section with the adjacent label switch node and in this case, the provisioning information exchange processing section may be configured such that it exchanges the message with the provisioning information added thereto through the tunnel label switch path set by the tunnel label switch path setting section.

The provisioning information exchange processing section may be configured such that it adds a TLV for transferring the provisioning information to one of or both of initialization message and address message transmitted and received according to the label distribution protocol between the adjacent label switch nodes.

The provisioning information exchange processing section may be configured such that it exchanges a message for transferring the provisioning information newly defined by the label distribution protocol or may be configured such that it exchanges a message for withdrawing the provisioning information newly defined by the label distribution.

### BRIEF DESCRIPTION OF THE DRAWINGS

FIG. 1 is a diagram showing a configuration of an MPLS network (a label switch network) as an embodiment of the present invention.

FIG. 2 is a function block diagram showing a configuration of an LSR in the present embodiment.

FIG. 3 is a diagram for explaining an extension example of an LDP PDU in the present embodiment.

FIG. 4 is a format diagram for explaining a new definition example of a Session TYPE TLV in the present embodiment.

FIG. 5 is a format diagram for explaining a new definition example of an Application TYPE TLV in the present embodiment.

FIG. 6 is a format diagram for explaining a new definition example of a Session Name TLV in the present embodiment.

FIG. 7 is a format diagram for explaining an extension example of a Hello Message in the present embodiment.

FIG. 8 is a format diagram for explaining a Common Hello Parameters TLV in the present embodiment.

FIG. 9 is a format diagram for explaining an extension example 1 of an Initialization Message in the present embodiment.

FIG. 10 is a format diagram for explaining a Common Session Parameters TLV in the present embodiment.

FIG. 11 is a format diagram for explaining a new definition example of a Provisioning Information TLV in the present embodiment.

FIG. 12 is a format diagram for explaining a Pseudo Wire (PW) parameter TLV in the present embodiment.

FIG. 13 is a format diagram for explaining a new addition example of a Provisioning Message in the present embodiment.

FIG. 14 is a format diagram for explaining an extension example of an Address Message in the present embodiment.

FIG. 15 is a sequence diagram for explaining the procedure of establishing an LDP session in an MPLS network in the present embodiment.

FIG. 16 is a sequence diagram for explaining the procedure of establishing an LDP session in a conventional MPLS network.

FIG. 17 to FIG. 21 are diagrams showing exemplary network configurations for explaining the establishment of an LDP session of the conventional “Martini” scheme and an LSP, respectively.

### DESCRIPTION OF THE PREFERRED EMBODIMENTS

Embodiments of the present invention are explained below with reference to drawings.

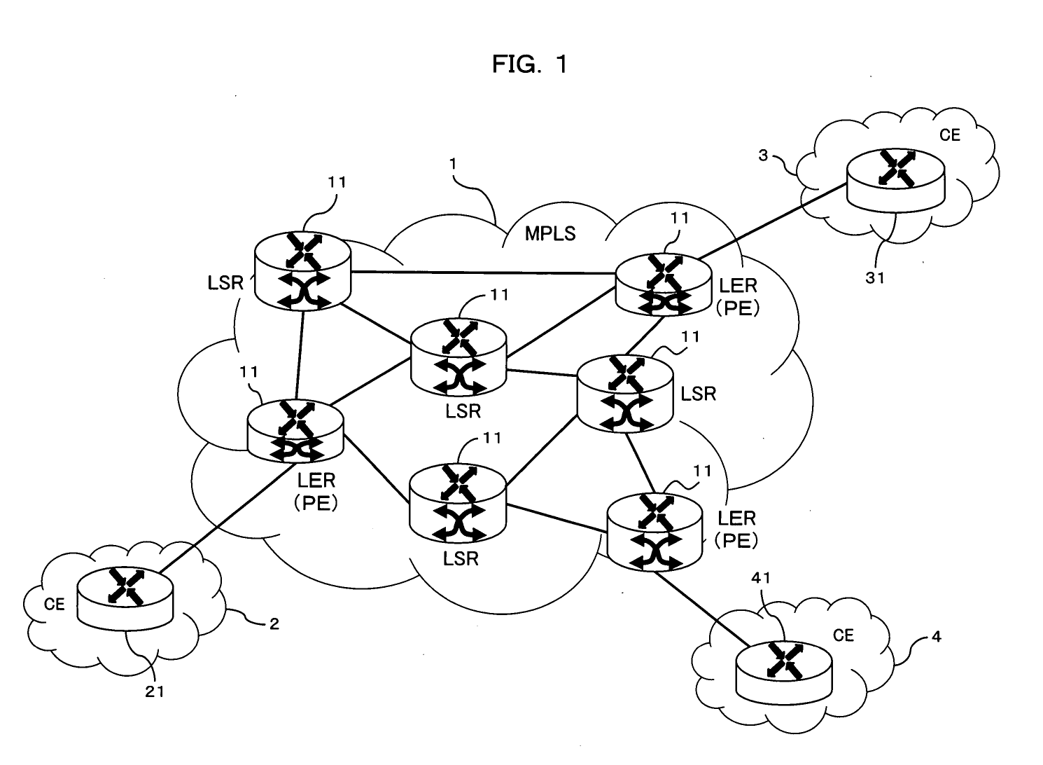

FIG. 1 is a diagram showing a configuration of an MPLS network (a label switch network) as an embodiment of the present invention. An MPLS network 1 shown in FIG. 1 is constituted of LSRs 11 as a plurality of label switch nodes supporting the MPLS function mutually connected in a mesh-like pattern. To the MPLS network 1, external networks 2, 3, and 4 are connected via normal routers (or bridges) 21, 31, and 41 constituting the external networks 2, 3, and 4. The LSR 11 located at the connection point with the external network 2, 3, or 4 [the router (or bridge) 21, 31, or 41] is particularly referred as an LER (Label Edge Router) (corresponding to a PE in the IP-VPN) and other LSRs 11 are referred to as core LSRs.

In such a network configuration, in the present invention, (1) it is made possible to establish a plurality of LDP sessions between the same adjacent LSRs 11 and at the same time, (2) it is made possible to explicitly identify an application and/or usage utilizing the LDP session, and (3) it is made possible to automatically detect the Provisioning Information of the LSR 11 and to detect erroneous wiring (erroneous connection) due to an error of Provisioning Information and/or a setting error of Provisioning Information.

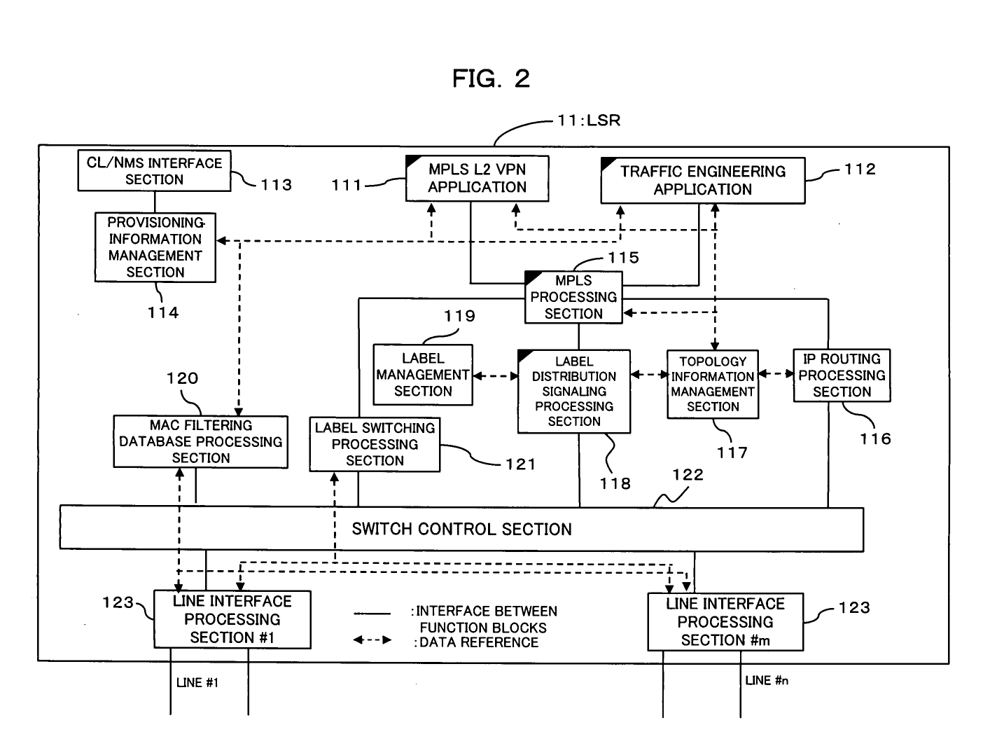

Therefore, the LSR 11 in the present embodiment comprises, if its essentials are focused on, as shown in FIG. 2 for example, an MPLS L2 VPN application section 111, a traffic engineering application section 112, a CL/NMS interface section 113, a provisioning information management section 114, an MPLS processing section 115, an IP routing processing section 116, a topology information management section 117, a label distribution signaling processing section 118, a label management section 119, a MAC filtering database processing section 120, a label switching processing section 121, a switch control section 122, a line interface section 123, etc. In FIG. 2, the solid lines denote interfaces between these function blocks and the dotted line arrows denote data reference (access) paths between the function blocks.

Here, the MPLS L2 VPN application section 111 directs the MPLS processing section 115 to perform, as the need arises, establishment/release of a session of label distribution signaling, establishment/release of a tunnel LSP, establishment/release of a PW LSP, mapping between the tunnel LSP and a PW LSP and/or mapping between the PW LSP and an attachment circuit, etc., according to Provisioning Information managed by the provisioning information management section 114, and in the present embodiment, its functions have been extended as follows.

(1) Session identification information (Session ID) is added for identifying the session on directing to establish the session by the label distribution signaling (LDP). The Session ID may be automatically generated in the application section 111 or may be subjected to provisioning (managed by the provisioning information management section 114).

(2) An instruction is added to acquire Provisioning Information on the remote side on directing to establish the session by the label distribution signaling.

(3) An instruction is added to check Provisioning Information on the remote side device and Provisioning Information of its own device on directing to establish the session by the label distribution signaling. Further, according to the check result, establishment/release of the session is judged.

The traffic engineering application section 112 performs, as the need arises, establishment/release of a session by the label distribution signaling, establishment/release of a load distribution LSP, and an instruction of load distribution parameters (a plurality of LSP for mapping, the load distribution upper limit threshold value, the load distribution lower limit threshold value, etc.) for the MPLS processing section 115 according to Provisioning Information managed by the provisioning information management section 114, and in the present embodiment, its functions have been extended such that a Session ID can be added on directing to establish the session by the label distribution signaling. The Session ID may also be automatically generated in the application section 112 or may be subjected to provisioning.

The CL/NMS interface section 113 manages the interface with a command line (CL) and/or a network management system (NMS) and here, it has a function of setting and displaying management information, etc., in cooperation with the provisioning information management section 114. Further, the provisioning information management section 114 sets/displays Provisioning Information according to the instruction from the CL/NMS interface section 113 and at the same time, makes it possible for each function block to refer to the Provisioning Information. As for the Provisioning Information on the remote side, setting from the corresponding function block may be made possible (it may be an object to be managed).

The MPLS processing section 115 directs the label distribution signaling processing section 118 to perform establishment/release of a session by the label distribution signaling and establishment/release of various LSPs according to the instruction from the various applications (here, the MPLS L2 VPN application section 111 and the traffic engineering application section 112), or receives requests of establishment/release of a session by the label distribution signaling and establishment/release of various LSPs from the remote side LSR via the label distribution signaling processing section 118. It also performs establishment/release of the LSP and has a function of directing the label switching processing section 121 to perform setting/modification/release, etc., of the label forwarding table according to the instruction parameter from the application.

In other words, the MPLS processing section 115 functions as a session establishment control section for controlling the establishment of the required LDP session in accordance with the label distribution signaling message (LDP message) received from the adjacent LSR via the label distribution signaling processing section 118, which will be described later. However, in the present embodiment, its functions have also been extended as follows.

(1) A Session ID is added on directing to establish a session by the label distribution signaling.

(2) An instruction is added to acquire Provisioning Information on the remote (other party) side device (LSR) on directing to establish a session by the label distribution signaling.

(3) The Provisioning Information on the above-mentioned remote side device is checked, if necessary, its result is notified to the specified application, and a subsequent instruction is waited for.

Next, the IP routing processing section 116 maintains the dynamic topology information of the network 1 by executing the IP routing protocol in cooperation with the topology information management section 117, and the topology information management section 117 maintains and manages the dynamic topology information of the network in cooperation with the IP routing process section 116 and at the same time, provides the topology information and its change to the function blocks the require them.

The label distribution signaling processing section (the label distribution protocol processing section) 118 performs establishment/release of a session by the label distribution signaling and establishment/release of the various LSPs from the instruction from the MPLS processing section 115 and at the same time, notifies the MPLS processing section 115 of the requests of establishment/release of a session by the label distribution signaling and establishment/release of the various LSPs from the remote side device and waits for a instruction of the subsequent processing. Here, its functions have been extended in a variety of ways (the extension of the LDP: details will be described later) in such a manner that the LDP message is extended such that it is made possible to give/exchange the above-mentioned Session ID, information (Session TYPE information) explicitly indicating one of or both of an application and its usage of the LDP session to be established, Provisioning Information, etc.

The label management section 119 provides the space management function of the label assigned by its own device to the above-mentioned label distribution signaling processing section 118 and the MAC (Media Access Control) filtering database processing section 120 manages the original of the MAC filtering database in cooperation with the provisioning information management section 114 and the line interface processing section 123 (#1 to #m: m is a natural number) and provides the required MAC filtering database to each of the line interface processing sections 123 and at the same time, directs the switch control section 122 to perform required switching.

The label switching processing section 121 manages the original of the label forwarding table according to the instruction from the MPLS processing section 115 and provides each of the line interface processing sections 123 with the required label forwarding table and at the same time, directs the switch control section 122 to perform required switching.

The switch control section 122 performs switching between each of the line interface processing sections 123 and the required function block in its own device according to the instruction from the MAC filtering database processing section 120 and the label switching processing section 121 and the respective line interface processing sections 123 accommodate one or more lines (#1 to #n) and transmit and receive a frame by referring to the MAC filtering database/label forwarding table (not shown schematically) according to the instruction from the MAC filtering database processing section 120 and the label switching processing section 121.

Next, specific examples of the above-mentioned various functional extensions are described below in detail.

(a) First, in order to make it possible to establish a plurality of LDP sessions between the same adjacent LSRs 11, the LDP (RFC3036) is extended. As a specific example, the following schemes <1> and <2> are conceivable.

<1> Extension of LDP Identifier (Modification)

The LDP identifier is extended (modified) without changing the format of the LDP PDU, it is made possible to identify the plurality of LDP sessions between the same adjacent LSRs 11 with the session identification information (Session ID).

In this case, the LDP identifier is composed of, according to RFC3036, “LSR ID” (a global value consisting of four octets for identifying the LSR) and “Label space ID” (a value consisting of two bits for identifying the Label space: “0” denotes the “platform-wide” Label space, “1” denotes the “per interface” Label space, and “3” and “4” denote reserves), however, a “Session ID” consisting of 14 bits is newly defined and displayed as a session number in the “platform-wide” Label space, and in the “per interface” Label space, the first 10 bits are displayed as “Interface ID” and the rest is displayed as a session number.

<2> Extension of LDP PDU

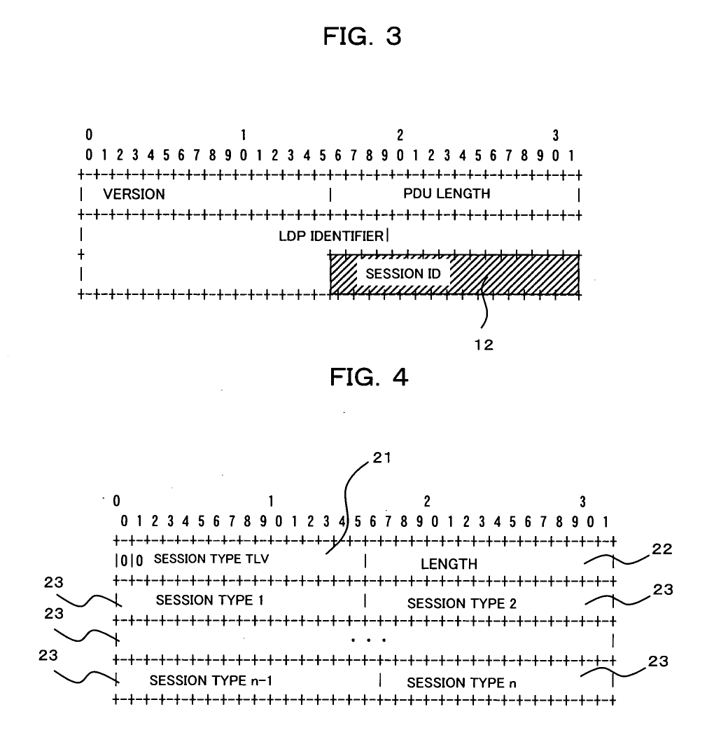

For example, as shown in FIG. 3, a Session ID field 12 is newly defined as an addition to the LDP PDU format.

(b) By adding a TLV explicitly indicating one of or both of an application and its usage of the LDP session to be established to an LDP message (for example, Hello Message), exchange of the application and/or its usage of the session is performed between the same adjacent LSRs 11 on establishing Hello Adjacency, the session is established correctly, and thus an erroneous connection is prevented (the TLV may be added to an Initialization Message).

Specifically, a “Session TYPE TLV” indicating the type or usage of a session and/or an “Application TYPE TLV” indicating the type of an application utilizing the session and/or a “Session name TLV” indicating the name of the session are newly defined (these TLVs are referred to as “Session TYPE information” together), and for example, the TLV is transmitted and received by a Hello Message or an Initialization Message (via the label distribution signaling processing section 118) and only when they match, Hello adjacency or the LDP session is established. However, as for the “Session name TLV”, this is not limited to the above when it is used only for maintenance and operation.

In other words, the label distribution signaling processing section 118 in the present embodiment has a function as a hello message processing section for performing exchange of the information with the adjacent LSR on establishing Hello adjacency by adding “Session TYPE information” to the Hello Message as an LDP message.

Further, it may also be possible to newly define a “Session TYPE” parameter indicating the type or usage of a session and/or an “Application TYPE” parameter indicating the type of an application utilizing the session and/or a “Session name” parameter with the Common Session Parameters TLV of the Initialization Message, transmit and receive the above-mentioned parameters, and establish Hello adjacency or an LDP session only when they match. However, as for the “Session name TLV”, this is not limited to the above when it is used only for maintenance and operation.

In other words, in this case, the label distribution signaling processing section 118 has a function as an initialization message processing section for performing exchange of the information with the adjacent LSR on establishing Hello adjacency by adding “Session TYPE information” to the Initialization Message as an LDP message.

The above-mentioned message may be transmitted and received in a tunnel LSP or through an IP path.

Examples of addition and modification of the above-mentioned message, TLV, and parameter are shown below.

<3> Example of New Definition of “Session TYPE TLV”

FIG. 4 shows an example of new definition of a “Session TYPE TLV”. As shown in FIG. 4, the “Session TYPE TLV” is prepared with a “TLV TYPE” field 21 indicating the type of a TLV, a “Length” field 22, and a “Session TYPE” field 23, and the “TLV TYPE” field 21 is set with information indicating the type of the TLV (in this case, “Session TYPE”), the “Length” field 22 is set with information indicating the length of the TLV, and the “Session TYPE” field 23 is set with information indicating the type of a session to be set, respectively.

For example, it is assumed that “0” indicates a basic ldp session, “1” indicates an ldp session for control message, and “2” indicates an ldp session for data plane message (others are assumed to be reserves). By the way, as for the “Session TYPE”, it is possible to set a plurality of supported types as shown in FIG. 4.

<4> Example of New Definition of “Application TYPE TLV”

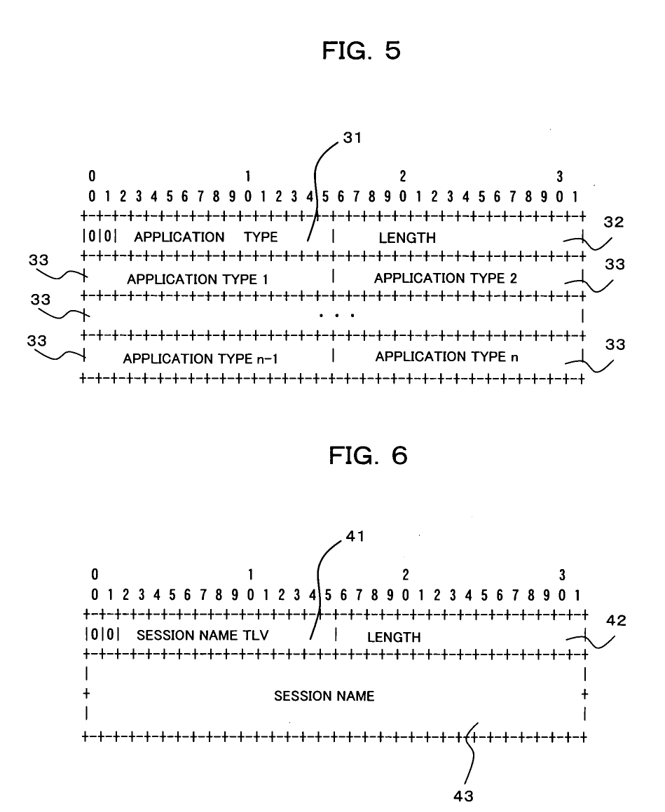

Next, FIG. 5 shows an example of new definition of an “Application TYPE TLV”. As shown in FIG. 5, the “Application TLV” is prepared with a “TLV TYPE” field 31, a “Length” field 32, and an “Application TYPE” field 33, and the “TLV TYPE” field 31 is set with information indicating the type of the TLV (in this case, “Application”), the “Length” field 32 is set with information indicating the length of the TLV, and the “Application TYPE” field 33 is set with information indicating the type of a session to be set, respectively.

For example, it is assumed that “0” indicates “unknown”, “1” indicates a traffic engineering session, and “2” indicates a “Martini L2 VPN” session, respectively (others are assumed to be reserves). By the way, as for the “Application TYPE”, it is also possible to set a plurality of supported types as shown in FIG. 5.

<5> Example of New Definition of “Session Name TLV”

FIG. 6 is a diagram showing an example of new definition of a “Session Name TLV”, and as shown in FIG. 6, the “Session Name TLV” is prepared with a TLV TYPE field 41, a “Length” field 42, and a “Session Name” field 43, and the “Session Name TLV” field 41 is set with information indicating the type of the TLV (in this case, “Session Name”) and the “Length” field 42 is set with information (character string) indicating a session to be set.

<6> Example of Extension of “Hello Message”

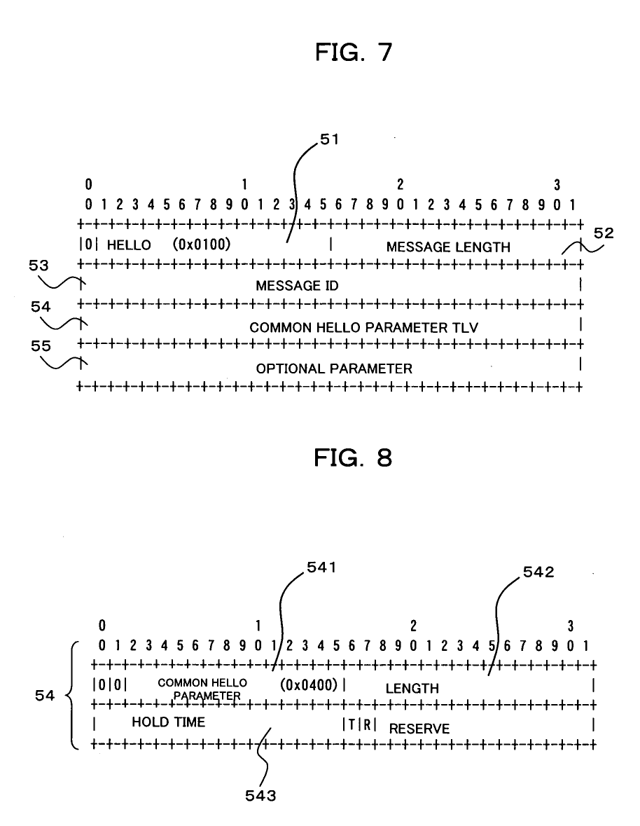

Next, FIG. 7 and FIG. 8 show examples of extension of a “Hello Message”. As shown in FIG. 7 and FIG. 8, the “Hello Message” is prepared with a Message TYPE field 51 indicating the message type [in this case, Hello (0x0100)], a Message Length field 52 indicating the Message Length, a Message ID field 53, a Common Hello Parameters TLV field 54, and an optional parameter field 55, and further, the Common Hello Parameters TLV field 54 is prepared with a field 541 indicating the parameter type (Common Hello Parameters), a Length field 542 indicating the length (field length) of the Common Hello Parameters TLV field 54, a Hold Time field 543, etc.

Then, in the present embodiment, information (optional parameter) to be set to the above-mentioned optional parameter filed 55 is extended to make it possible to set each piece of information of “Session TYPE” (Session TYPE TLV), “Application TYPE” (Application TYPE TLV), and “Session Name” (Session Name TLV” in addition to already existing parameters (“IPv4 Transport Address (0x0401)”, “Configuration (0x0402)”, and “IPv6 Transport Address (0x0403)”).

By performing exchange of a Hello packet having such extended optional parameters between the adjacent LSRs 11, it is made possible to explicitly specify an application and/or usage of an LDP session to be established on establishing Hello adjacency.

<7> Extension Example 1 of “Initialization Message”

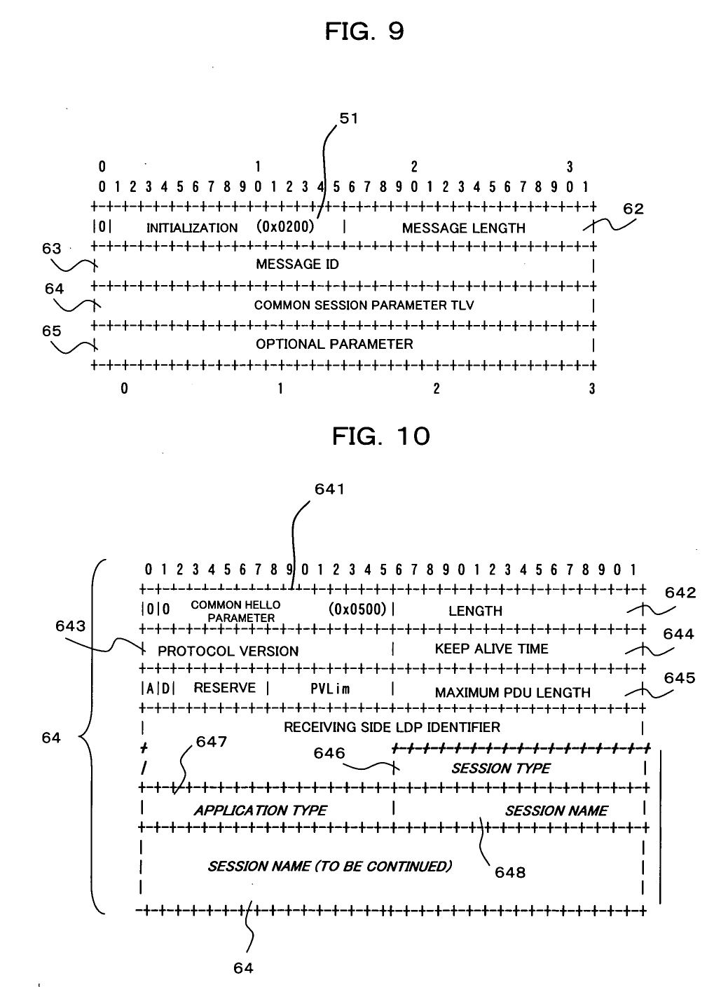

Next, FIG. 9 shows an extension example 1 of an “Initialization Message”. As shown in FIG. 9, the “Initialization” is prepared with a Message TYPE field 61 indicating the message type [in this case, “Initialization (0x0200)”], a Message Length field 62 indicating the Message Length, a Message ID field 63, a Common Session Parameters TLV field 64, and an optional parameter field 65.

On the other hand, as shown in FIG. 10, the above-mentioned Common Session Parameters TLV field 64 is further prepared with a field 641 indicating the parameter type (Common Session Parameters), a Length field 642 for setting the length (field length) of the Common Session Parameters TLV field 64, a protocol version field 643, a Keep Alive Time field 644, and a Receiver LDP Identifier) field 645.

Then, in the present embodiment, as shown in FIG. 10, to the Common Session Parameters TLV field 64, a “Session TYPE” field 646, an “Application TYPE” field 647, and a “Session Name” field 648 are additionally defined to make it possible to set each piece of information of “Session TYPE”, “Application TYPE”, and “Session Name”.

By performing exchange of an Initialization Message having such extended Common Session Parameters between the adjacent LSRs 11, it is made possible to explicitly specify an application and/or usage of an LDP session to be established on establishing the LDP session.

<8> Extension Example 2 of “Initialization Message”

When an Initialization Message is used to explicitly specify an application and/or usage of an LDP session to be established, its optional parameter may be extended. In other words, it is made possible to set each piece of information of the above-mentioned “Session TYPE” (Session TYPE TLV), “Application TYPE” (Application TYPE TLV), and “Session Name” (Session Name TLV) in addition to the already existing parameters (“ATM Session Parameters (0x0501)”, “Frame Relay Session (0x0502)”, etc.) as an optional parameter.

In this manner also, it is made possible to explicitly specify an application and/or usage of an LDP session to be established on establishing the LDP session.

As described above, it is made possible to set a plurality of LDP sessions using the same label space between the same adjacent LSRs 11 and at the same time, it is made possible to explicitly specify (identify) a usage and/or application of the LDP session.

(c) Next, in the present embodiment, it is made possible to automatically acquire [or delete (withdraw)] information on the remote side and detect erroneous wiring and/or a setting error of Provisioning Information by transmitting and receiving Provisioning Information by an LDP Message. Here, the Provisioning Information may be added to an already existing message (for example, Initialization Message) as a new TLV or a message itself may be defined newly. However, as for information having the high possibility of addition/modification, it is preferable to use a new message or an address message. Thus, it is possible to check and prevent in advance erroneous operations of the MPLS and an application due to the error of provisioning.

Its specific examples are shown in <9>, <10>, <11>, and <12> as follows. Such a function is also realized by the functional extension of the label distribution signaling processing section 118.

<9> Example of New Definition of “Provisioning Information TLV”

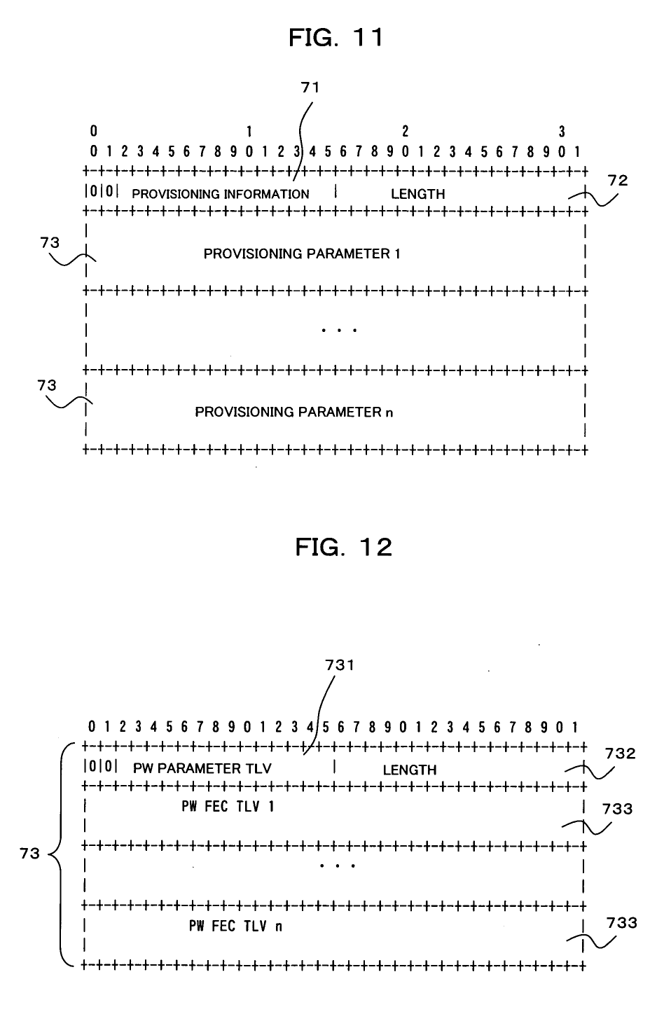

FIG. 11 shows an example of new definition of “Provisioning Information TLV”. As shown in FIG. 11, the “Provisioning Information TLV” is prepared with a TLV TYPE field 71 indicating the TLV type (in this case, “Provisioning Information”), a TLV Length field 72 indicating the length of the “Provisioning Information TLV”, and a Provisioning Parameter field 73, and it is made possible to set a plurality of “Pseudo Wire Parameter TLV” having the format shown in FIG. 12 as the Provisioning Parameter.

As shown in FIG. 12, the “Pseudo Wire Parameter TLV” is prepared with a TLV TYPE field 731 indicating the TLV type (in this case, “Pseudo Wire Parameter”), a TLV Length field 732 indicating the TLV length, and a “PW FEC TLV” field 733, and it is made possible to set a plurality of “PW FEC TLVs” (defined by the “Martini” draft described before).

By performing exchange of a “Provisioning Information TLV” between the adjacent LSRs 11, it is made possible to automatically acquire [or delete (withdraw)] the Provisioning Information on the other party (remote) side and at the same time, to detect erroneous wiring and/or setting errors of the Provisioning Information on a PW basis. In other words, the label distribution signaling processing section 118 in the present embodiment also functions as a provisioning information exchange processing section for adding the Provisioning Information about the entity of the LDP to an LDP message and performing exchange of the message with the adjacent LSR.

<10> Extension Example of “Initialization Message”

When an Initialization Message is used for exchange of Provisioning Information, by extending its optional parameter (refer to FIG. 9), for example, it is made possible to further set each piece of information of “Provisioning Information” (“Provisioning Information TLV”) in addition to the already existing parameters (“ATM Session Parameters (0x0501)”, “Frame Relay Session (0x0502), etc.) and aforementioned “Session TYPE” (Session TYPE TLV), “Application TYPE” (Application TYPE TLV), and “Session Name” (Session Name TLV).

By performing exchange of an Initialization Message having such extended optional parameters between the adjacent LSRs 11, it is made possible to automatically acquire [or delete (withdraw)] the Provisioning Information on the other party (remote) side and at the same time, to detect erroneous wiring and/or setting errors of the Provisioning Information on establishing an LDP session.

<11> Example of New Addition of “Provisioning Message”

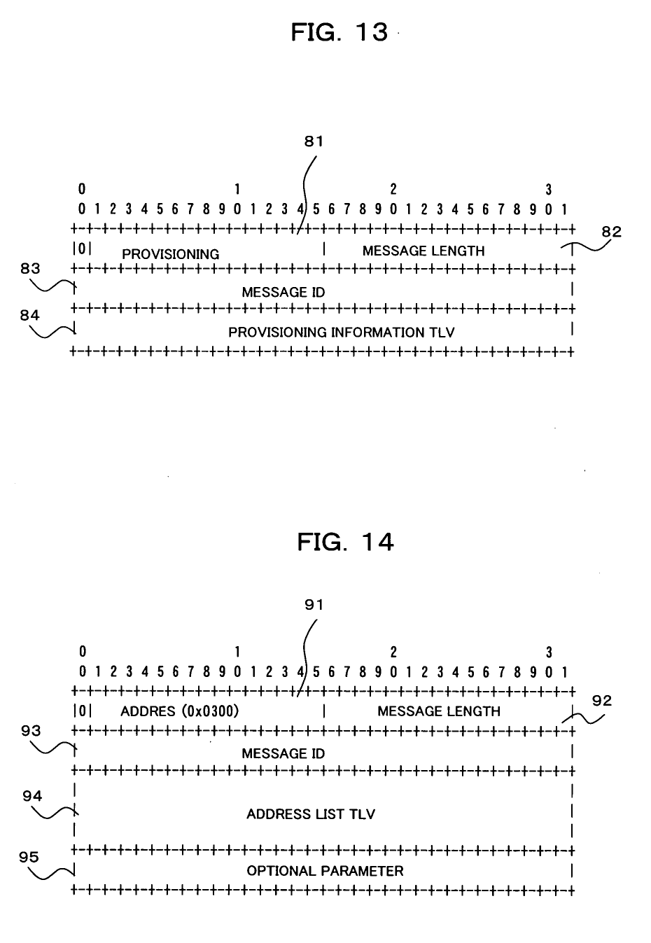

Next, when a message (Provisioning Message) dedicated for performing exchange of Provisioning Information is newly defined as an addition (it is generated in the label distribution signaling processing section 118), the format as shown in FIG. 13 is adopted, for example. In other words, the Provisioning Message is prepared with a Message Type field 81 indicating the Message type (in this case, “Provisioning), a Message Length field 82 indicating the Message length, a Message ID field 83, and a Provisioning Information TLV field 84, and by setting the Provisioning Information (Provisioning Information TLV) of its own LSR 11 to the field 84, it is made possible to perform exchange of Provisioning Information between the adjacent LSRs 11.

<12> Extension Example of “Address Message”

Next, when exchange of Provisioning Information is performed using an Address Message by the LDP (a message for exchange after an LDP is established), it is made possible to set “Provisioning Information TVL” as Provisioning Information by extending the parameters to be set to the optional parameter field 95 of an Address Message having a Message TYPE field 91 indicating the Message type (in this case, “Address” is displayed), a Message Length field 92 indicating the Message length, a Message ID field 93, an Address List TLV field 94, and an optional parameter field 95.

Thus, even after the establishment of an LDP session, it is made possible to automatically acquire [or delete (withdraw)] the Provisioning Information on the other party (remote) side appropriately and at the same time, to detect erroneous wiring and/or setting errors of Provisioning Information. By the way, exchange of the above-mentioned Provisioning Information may be performed by using one of the Initialization Message and the Address Message or may be performed by using both.

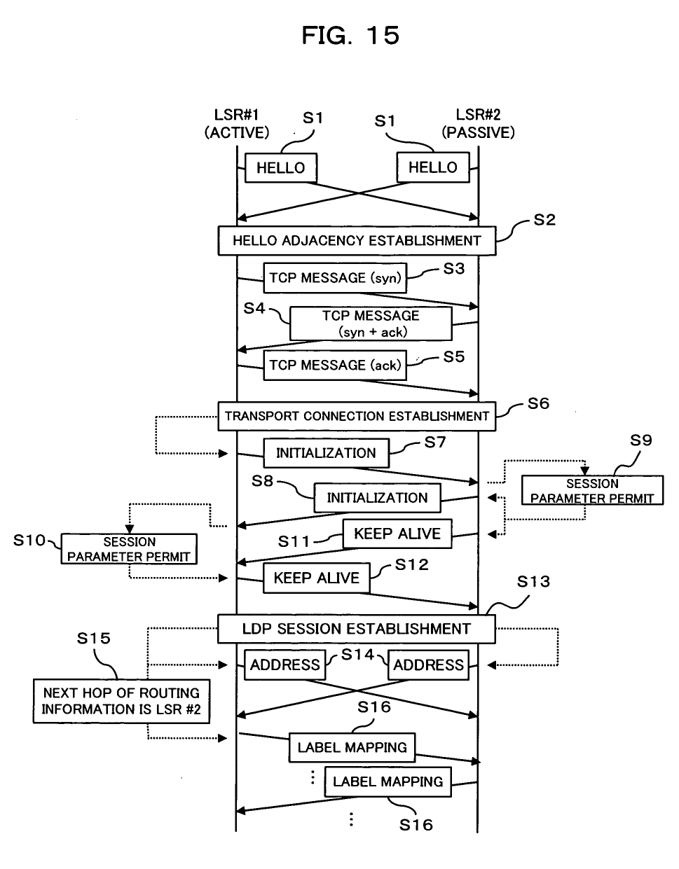

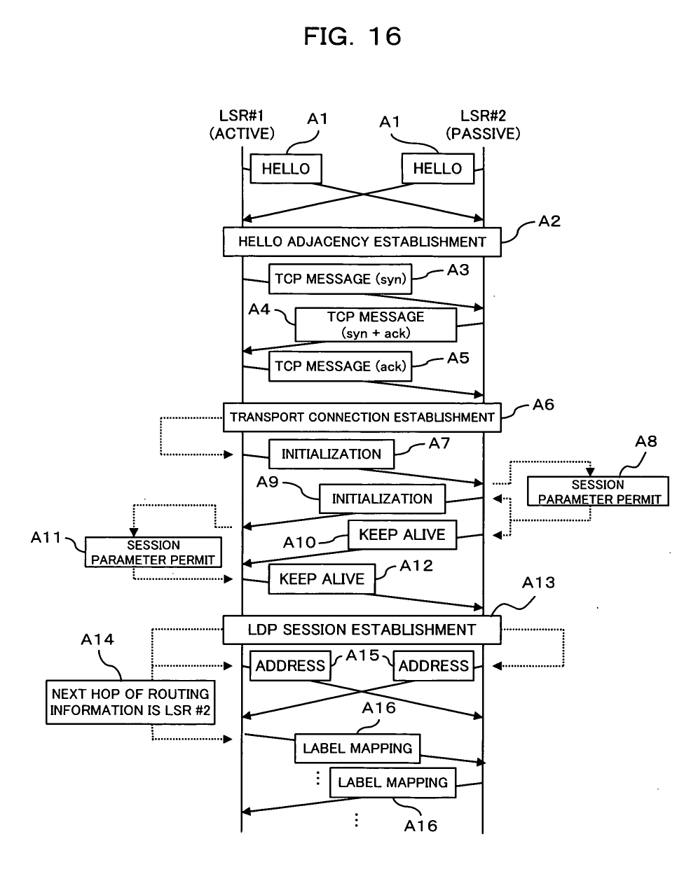

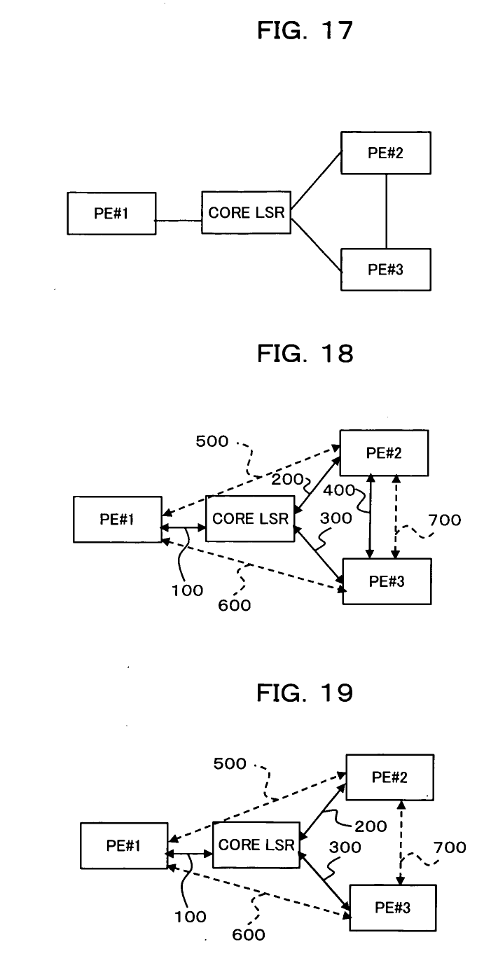

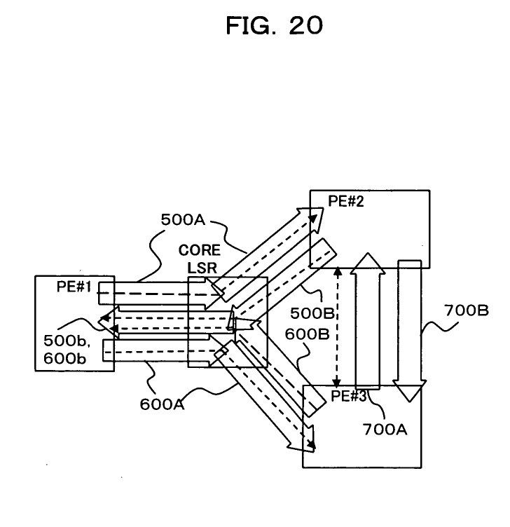

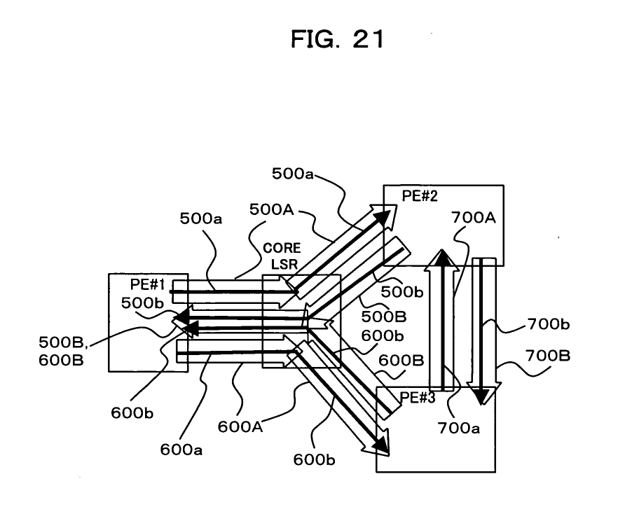

(d) Next, a technique is explained below with reference to the sequence diagram shown in FIG. 15, which technique will obviate provisioning of the information by explicitly and correctly setting the LDP session for the corresponding application and/or usage of the adjacent LSR 11 and at the same time, by automatically acquiring [or deleting (withdrawing)] the Provisioning Information on the remote side using the TLV additionally defined as described above in the above-mentioned items (a) and (b). Here, a method for automatically detecting Hello adjacency is explained below with the extension of the “Martini” draft as an example.

As shown in FIG. 15, first, exchange of a Hello Message is performed between adjacent PEs 11 [LSR#1 (active) and LSR#2 (passive) are assumed] connected to the MPLS network 1 and having implemented the MPLS L2 VPN according to the “Martini” draft using the respective functions of the respective label distribution signaling processing sections 118 (step S1). At this time, by extending the LDP identifier or LDP PDU of the Hello Message to give it a Session ID as described above in items <1> and <2>, it is made possible to explicitly specify/identity a plurality of LDP sessions between LSR#1 and LSR#2. By the way, as for the Session ID, by giving it to all of the Messages shown in FIG. 15, it is made possible to establish a plurality of LDP sessions using the same Label space between adjacent LSR#1 and LSR#2.

As described above in items <3>, <4>, <5>, and <6>, by giving the “Session TYPE TLV” and/or the “Application TYPE TLV” and/or the “Session Name TLV” to the above-mentioned Hello message, it is made possible to explicitly specify/identify an application and/or its usage utilizing an LDP Session to be established and it is also made possible to correctly establish Hello adjacency explicitly indicating the application and/or it usage (step S2).

Further, it is made possible to automatically detect the address of the LDP entity that process the “Martini” scheme on the remote side by setting LSPs (tunnel LSPs) in a full-mesh pattern between the adjacent LSRs (PEs) 11 by a normal LSP to logically and directly connect the adjacent LSRs 11 before exchange of the Hello Message (thereby, it is made possible to use the basic discovery mechanism using a tunnel LSP) by using the function of the label distribution signaling processing section 118 (the function as a tunnel LSP setting section for setting a tunnel LSP in advance with the adjacent LSR), by giving the “Session TYPE TLV” and/or the “Application TYPE TLV” and/or the “Session Name TLV” described above in items <3>, <4>, and <5> to the above-mentioned Hello Message, and by transmitting the Hello Message to each other with the destination address being a multicast address (224.0.0.2) (the basic discovery).

When Hello adjacency is established as described above, a transport connection is established next between the adjacent LSR#1 and LSR#2 (step S6) by exchange of a TCP message (steps S3 to S5) and using the respective functions of the respective label distribution signaling processing sections 118, exchange of an Initialization Message is performed (step S7, S8). At this time, by extending the Initialization Message as described in items <3>, <4>, <5>, <7>, and <8>, it is made possible to explicitly specify/identify an application and/or its usage utilizing the LDP session in this phase also.

Further, by adding a “Provisioning TLV” to the above-mentioned Initialization Message as described in items <9> and <10> to perform exchange of Provisioning Information, it is made possible to acquire [or delete (withdraw)] the Provisioning Information on the remote side and at the same time, to check out unmatch of the Provisioning Information and inform a maintenance person etc. of it in the MPLS processing section 115. The address setting on the remote side is no longer necessary. If the unmatch of the Provisioning Information is detected in the MPLS processing section 115, the subsequent processing may be continued or aborted. Depending on the information for exchange, it may also be possible to deal with it by adding a new TLV to the Address Message.

As described in item <11>, by newly defining a Provisioning Message as an addition and performing exchange of the Provisioning Message to which a “Provisioning Information TLV” has been added between the adjacent LSR#1 and LSR#2 after the LDP session is established, it is made possible to acquire [or delete (withdraw)] the Provisioning Information on the remote side and at the same time, to check out the unmatch of the Provisioning Information and inform a maintenance person etc. of it also after the LDP session is established. Also in this case, the subsequent processing may be continued or aborted.

After permitting the session parameters of the Initialization Message for each other by exchange of the above-mentioned Initialization Message, the adjacent LSR#1 and LSR#2 inform the remote side of their own normal operations by issuing a Keep Alive Message periodically (steps S11, S12). As described above, a plurality of LDP sessions using the same Label space are established between the adjacent LSR#1 and LSR#2 with the application and/or its usage utilizing the session.

After this, the adjacent LSR#1 and LSR#2 perform exchange of the address of the LDP peer used for the forwarding decision of an MPLS packet (labeled packet) by an Address Message (step S14), and at this time, as described in item <12>, by extending the Address Message to add a new TLV, as in the case where the Initialization Message is utilized, it is made possible to acquire [or delete (withdraw)] the Provisioning Information on the remote side and at the same time, to check out the unmatch of the Provisioning Information and inform a maintenance person etc. of it. Also in this case, the processing after the unmatch is detected may be continued or aborted. As for the information not modified during the session, it may also be possible to deal with it by adding a “Provisioning Information TLV” to the Initialization Message.

Then, the adjacent LSR#1 and LSR#2 perform label distribution (label mapping) by performing exchange of a label mapping message based on the contents of the information of the Address Message received from each other (steps S15, S16). Thereby, it is made possible to perform forwarding the MPLS packet added with the distributed label at each of the LSR#1 and LSR#2.

As described above, according to the present embodiment, it is made possible to set a plurality of LDP sessions using the same Label space between the same adjacent LSRs and further, it is made possible to explicitly indicate its usage (application), therefore, it is possible to connect the LDP session without errors and to detect in the early stage erroneous provisioning and an erroneous connection of the session owing thereto on establishing the session.

It is also possible to prevent an erroneous operation of the MPLS and application owing to the error of provisioning, and further, to automatically detect the Provisioning Information about the remote side LSR, to obviate (or reduce) the provisioning of the remote side information, and to reduce an erroneous connection or an erroneous operation owing to the provisioning error.

Therefore, in the network composed of devices that have implemented the MPLS and/or the GMPLS and/or the protocol extended from the former (packet repeater/TDM repeater/optical wavelength repeater, etc.), when an application using the MPLS and/or the GMPLS and/or the protocol extended from the former is realized, the simplification in designing, the improvement in flexibility, the improvement in efficiency of maintenance/operation/management, etc., can be expected.

Further, the interconnectivity is effectively improved between functionally restricted devices such as one based on the bridge and to which the MPLS (for example, the “Martini” scheme) is implemented because of the implementation cost or restriction of hardware, or between such a functionally restricted device and a device provided with general purpose functions.

As described above, according to the present invention, the simplification in designing, the improvement in flexibility, the improvement in efficiency of maintenance/operation/management, etc., of a label switch network can be expected and at the same time, the improvement in interconnectivity between functionally restricted devices or between a functionally restricted device and a device general-purposely equipped with functions can also be expected, therefore, the present invention can be considered to have great utility in the field of network communication.

1. A method for establishing a session in a label switch network comprising a plurality of label switch nodes having a function of routing a received packet according to label information distributed by a predetermined label distribution protocol,
wherein:
message exchange between adjacent label switch nodes by said label distribution protocol is performed by adding session identification information to the message for identifying a session to be established between the same adjacent label switch nodes; and
the same adjacent label switch nodes respectively establish a plurality of sessions to be used in the same label space between the same adjacent label switch nodes based on the session identification information.

2. A method for establishing a session in a label switch network comprising a plurality of label switch nodes having a function of routing a received packet according to label information distributed by a predetermined label distribution protocol,
wherein:
message exchange between adjacent label switch nodes by said label distribution protocol is performed by adding session type information to the message for explicitly indicating one of or both of an application and its usage utilizing a session to be established between said adjacent label switch nodes; and
said adjacent label switch nodes respectively establish the sessions in accordance with said session type information between said adjacent label switch nodes based on the session type information.

3. A method for establishing a session in a label switch network comprising a plurality of label switch nodes having a function of routing a received packet according to label information distributed by a predetermined label distribution protocol,
wherein:
message exchange between adjacent label switch nodes by said label distribution protocol is performed by adding session identification information to the message for identifying a session to be established between the adjacent same label switch nodes as well as session type information explicitly indicating one of or both of an application and its usage utilizing said session; and
the same adjacent label switch nodes respectively establish a plurality of sessions to be used in the same label space between the same adjacent label switch nodes based on the session identification information as well as said session type information.

4. The method for establishing a session in a label switch network according to claim 2, wherein exchange of session type information is performed by adding the session type information to a hello message as said message between said adjacent label switch nodes on establishing hello adjacency between said adjacent label switch nodes.

5. The method for establishing a session in a label switch network according to claim 2, wherein
exchange of session type information is performed by adding the session type information to an initialization message as said message between said adjacent label switch nodes on establishing session between the adjacent label switch nodes.

6. The method for establishing a session in a label switch network according to claim 1, wherein
on establishing said session between adjacent label switch nodes, exchange of provisioning information about the entity of said label distribution protocol is performed by adding the provisioning information to said message.

7. A label switch node having a function of routing a received packet according to label information distributed by a predetermined label distribution protocol, comprising:
a label distribution protocol processing section adapted to perform exchange of said message by adding session identification information for identifying a session to be established between the same adjacent label switch nodes to a message to be transmitted to and received from an adjacent label switch node by said label distribution protocol; and
a session establishment control section for controlling the establishment of a plurality of sessions to be used in the same label space with said adjacent label switch node based on session identification information added to a message by the label distribution protocol received from said adjacent label switch node by said label distribution protocol processing section.

8. A label switch node having a function of routing a received packet according to label information distributed by a predetermined label distribution protocol, comprising:
a label distribution protocol processing section adapted to perform exchange of said message by adding session type information explicitly indicating one of or both of an application and its usage utilizing a session to be established with said adjacent label switch node to a message to be transmitted to and received from an adjacent label switch node by said label distribution protocol; and
a session establishment control section for controlling the establishment of said session in accordance with said session type information with said adjacent label switch node based on session type information added to a message by said label distribution protocol received from said adjacent label switch node by said label distribution protocol processing section.

9. A label switch node having a function of routing a received packet according to label information distributed by a predetermined label distribution protocol, comprising:
a label distribution protocol processing section adapted to perform exchange of said message by adding session identification information for identifying a session to be established with said adjacent label switch node as well as session type information explicitly indicating one of or both of an application and its usage utilizing said session to a message to be transmitted to and received from an adjacent label switch node by said label distribution protocol; and
a session establishment control section for controlling the establishment of a plurality of sessions in accordance with said session type information to be used in the same label space with said adjacent label switch node based on session identification information and session type information added to a message by said label distribution protocol received from said adjacent label switch node by said label distribution protocol processing section.

10. The label switch node according to claim 8, wherein said label distribution protocol processing section is configured such that it comprises a hello message processing section adapted to exchange said session type information with said adjacent label switch node on establishing hello adjacency with said adjacent label switch node by adding said session type information to a hello message as said message by said label distribution protocol.

11. The label switch node according to claim 8, wherein said label distribution protocol processing section is configured such that it comprises an initialization message processing section for exchanging said session type information with said adjacent label switch node on establishing a session with said adjacent label switch node by adding said session type information to an initialization message as said message by said label distribution protocol.

12. The label switch node according to claim 7, wherein said label distribution protocol processing section is configured such that it comprises a provisioning information exchange processing section for exchanging provisioning information about the entity of said label distribution protocol by adding it to said message.

13. The label switch node according to claim 12,
wherein:
said label distribution protocol processing section is configured such that it comprises a tunnel label switch path setting section for setting a tunnel label switch path in advance with said adjacent label switch node when said session is established by said session establishment control section with said adjacent label switch node; and
said provisioning information exchange processing section is configured such that it exchanges the message with the provisioning information added thereto through said tunnel label switch path set by said tunnel label switch path setting section.

14. The label switch node according to claim 12, wherein said provisioning information exchange processing section is configured such that it adds a TLV (Type/Length/Value) for transferring said provisioning information to one of or both of initialization message and address message transmitted and received according to said label distribution protocol between said adjacent label switch nodes.

15. The label switch node according to claim 12, wherein said provisioning information exchange processing section is configured such that it exchanges a message for transferring said provisioning information newly defined by said label distribution protocol.

16. The label switch node according to claim 12, wherein said provisioning information exchange processing section is configured such that it exchanges a message for withdrawing said provisioning information newly defined by said label distribution protocol.
